(19) United States
(12) Patent Application Publication
(10) Pub. No.: US 2026/0003762 A1
(43) Pub. Date: Jan. 1, 2026

(54) CONTROLLING MACHINE-LEARNING MODELS IN REALTIME SYSTEMS

(71) Applicant: Lockheed Martin Corporation, Bethesda, MD (US)

(72) Inventors: Mustafa Zafar Abbasi, Austin, TX (US); Brandon Scott Liston, Marlton, NJ (US); Mauro Joseph Sanchirico, III, Marlton, NJ (US)

(21) Appl. No.: 18/758,147

(22) Filed: Jun. 28, 2024

(51) Int. Cl. G06F 11/34

(52) U.S. Cl. CPC G06F 11/3447

(57) ABSTRACT

A method for controlling machine-learning models in real-time or near real-time systems is provided. The method includes accessing a set of sensor data captured from sensors configured to detect operational parameters associated with an operation of a real-time or near real-time system, and further inputting the set of sensor data into an ensemble machine-learning model trained to generate a prediction of features of detected operational parameters based on the set of sensor data. The ensemble machine-learning model includes a plurality of machine-learning models trained to generate the prediction of the features. The method further includes outputting, by the ensemble machine-learning model, the prediction of the features, generating, based on the prediction of the features, an explainability output associated with each of the plurality of machine-learning models, and further generating, based on the explainability output, one or more relative commonality scores for each of the plurality of machine-learning models.

### TECHNICAL FIELD

This disclosure relates generally to real-time or near real-time systems, and, more specifically, to controlling machine-learning models in real-time or near real-time systems.

### BACKGROUND

Machine-learning models may generally include predictive or statistical models trained on large data sets for generating predictions of outputs in response to being inputted a new, but similar data set. In some instances, the machine-learning models may be applied to real-time or near real-time sensor data driven systems, which may often require the machine-learning models to generate accurate predictions both with low execution time and limited operator input. However, because existing machine-learning models may be generally trained, validated, and evaluated utilizing static data sets, existing machine-learning models may perform poorly when applied to real-time or near real-time sensor data driven systems (e.g., due to data drift and sensor noise). It may be thus useful to provide to techniques to improve the training, validation, and evaluation of machine-learning models for real-time or near real-time sensor data driven systems.

### BRIEF DESCRIPTION OF THE DRAWINGS

FIG. 1 illustrates a user-configurable ensemble machine-learning model system and user interface (UI) suitable for monitoring and controlling the real-time or near real-time performance of an ensemble machine-learning model, in accordance with certain embodiments.

FIG. 2 illustrates a user-configurable ensemble machine-learning model inference workflow for generating relative commonality scores and aggregated feature attributions of machine-learning models, in accordance with certain embodiments.

FIG. 3 illustrates a flow diagram of a method for providing a user-configurable ensemble machine-learning model system and user interface (UI) suitable for monitoring and controlling the real-time or near real-time performance of an ensemble machine-learning model, in accordance with certain embodiments.

FIG. 4 illustrates an example computing system that may be used by the systems and methods described herein, in accordance with certain embodiments.

### DESCRIPTION OF EXAMPLE EMBODIMENTS

### Overview

The present embodiments are directed to techniques for providing a user-configurable ensemble machine-learning model system and user interface (UI) suitable for monitoring and controlling the real-time or near real-time performance of each machine-learning model of an ensemble machine-learning model. In certain embodiments, one or more processors of a computing system access a set of sensor data captured from one or more sensors configured to detect one or more operational parameters associated with an operation of a real-time or near real-time system. In certain embodiments, the one or more processors may then input the set of sensor data into an ensemble machine-learning model trained to generate a prediction of one or more features of the detected one or more operational parameters based at least in part on the set of sensor data. For example, in one embodiment, the ensemble machine-learning model may include a plurality of machine-learning models trained to generate the prediction of the one or more features of the detected one or more operational parameters.

In certain embodiments, the one or more processors may then output, by the ensemble machine-learning model, the prediction of the one or more features of the detected one or more operational parameters. In certain embodiments, the ensemble machine-learning model may include one or more of a convolutional neural network (CNN), a deep neural network (DNN), a deep convolutional neural network (DCNN), a vision transformer (ViT), one or more sequence-to-sequence (Seq2Seq) models, one or more encoder-decoder sequence models, or one or more transformer models. In certain embodiments, the one or more processors may then generate, based at least in part on the prediction of the one or more features of the detected one or more operational parameters, an explainability output associated with each of the plurality of machine-learning models.

In certain embodiments, the one or more processors may then generate, based at least in part on the explainability output, one or more relative commonality scores for each of the plurality of machine-learning models. For example, in certain embodiments, the one or more processors may generate the one or more relative commonality scores further by generating one or more evaluation metrics indicative of how well each respective machine-learning model of the plurality of machine-learning models performed with respect to generating the prediction of the one or more features of the detected one or more operational parameters. In certain embodiments, the one or more processors may further generate, based at least in part on the explainability output, one or more aggregated feature attributions for each of the plurality of machine-learning models.

In certain embodiments, the one or more processors may then cause a user interface (UI) executing on a computing device to display a real-time or near real-time visual representation of the explainability output and the set of sensor data. In certain embodiments, the one or more processors may further cause the UI executing on the computing device to display a visual representation of the one or more relative commonality scores for each of the plurality of machine-learning models. In certain embodiments, the one or more processors may identify, based at least in part on the one or more relative commonality scores, that one or more machine-learning models of the plurality of machine-learning models performed poorly with respect to generating the prediction of the one or more features of the detected one or more operational parameters, and further decommissioning the identified one or more machine-learning models.

Technical advantages of particular embodiments of this disclosure may include one or more of the following. Certain systems and methods described herein provide a user-configurable ensemble machine-learning model system and user interface (UI) suitable for monitoring and controlling the real-time or near real-time performance of each machine-learning model of the ensemble machine-learning model. In certain embodiments, the user-configurable ensemble machine-learning model system and UI may be utilized to generate in real-time or near real-time explainable artificial intelligence (XAI) ensemble relative commonality scores and aggregated feature attributions. In certain embodiments, one or more sensors may provide inputs to an ensemble machine-learning model, which may then provide one or more outputs for display on a user interface (UI). The UI may display information to an operator to perform one or more decision-making tasks. Specifically, the UI may display visual feedback on the real-time or near real-time performance (e.g., real-time predictions or decisions) of each machine-learning model of the ensemble machine-learning model, and further provide the operator real-time or near real-time control over any of the machine-learning models currently being employed in the ensemble machine-learning model.

In this way, the user-configurable ensemble machine-learning model system and UI may allow the operator to view and monitor in real-time or near real-time whether one or more machine-learning models of the ensemble machine-learning model are generating predictions or making decisions using erroneous information (e.g., learned parameters or other information that may be internal to the model) or generally performing poorly. The operator may then utilize the user-configurable ensemble machine-learning model system and UI to deactivate and/or decommission the low-performance machine-learning models while the high-performance machine-learning models of the ensemble machine-learning model remain activated and/or commissioned for service. Further, as the different machine-learning models of the ensemble machine-learning model focus on correct or incorrect information in different environments, the user-configurable ensemble machine-learning model system and UI may also allow the operator, for example, to adjust for data drift between environments.

Accordingly, the present embodiments may reduce execution times and processing workloads of one or more processors utilized by the user-configurable ensemble machine-learning model system and UI and reduce storage capacity of one or more memory devices utilized by the user-configurable ensemble machine-learning model system and UI by selectively decommissioning specific machine-learning models when identified as performing poorly with respect to other machine-learning models as part of the same ensemble machine-learning models.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

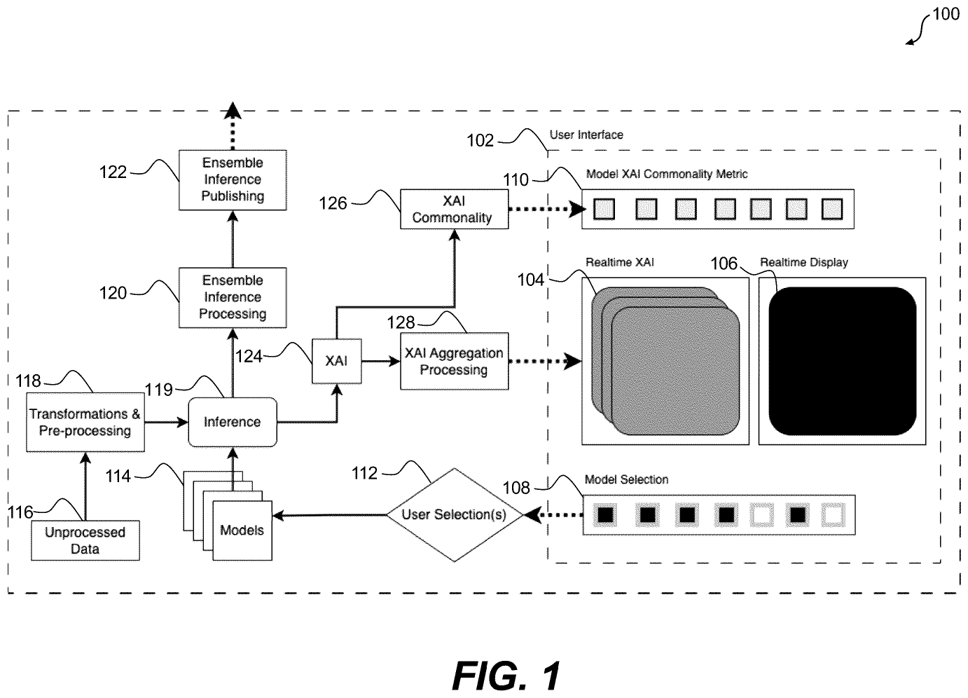

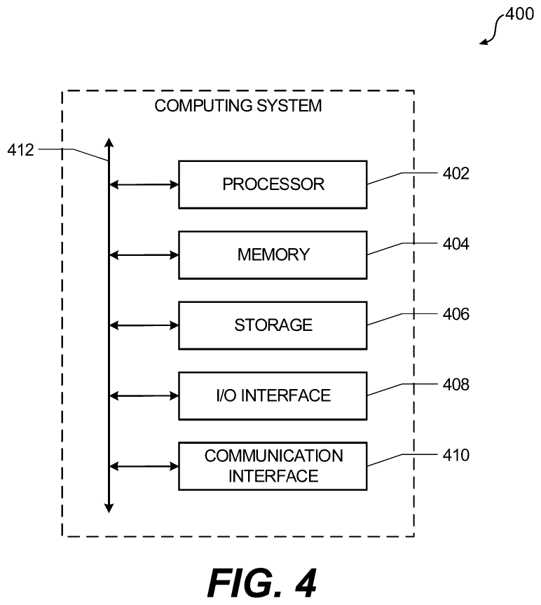

FIG. 1 illustrates a user-configurable ensemble machine-learning model system and user interface (UI) 100 suitable for monitoring and controlling the real-time or near real-time performance of an ensemble machine-learning model, in accordance with the presently disclosed embodiments. As depicted by FIG. 1, the user-configurable ensemble machine-learning model system and UI 100 may include user interface (UI) 102, which includes a real-time or near real-time explainable artificial-intelligence (XAI) operator display 104, a real-time or near real-time sensor data operator display 106, one or more machine-learning model selectable affordances 108 that may be selected by an operator (e.g., via user selection 112), and an explainable artificial-intelligence (XAI) relative commonality score indicators 110. In certain embodiments, the user-configurable ensemble machine-learning model system and UI 100 may be executed on a computing system, such as the computing system 400 as will be discussed below with respect to FIG. 4.

In certain embodiments, the computing system may access a data set of unprocessed sensor data 116. For example, in one embodiment, the data set of unprocessed sensor data 116 may be any raw sensor data that may be captured from one or more sensors utilized to detect one or more operational parameters associated with an operation of a real-time or near real-time system. In certain embodiments, the computing system may transform the data set of unprocessed sensor data 116 and generate a data set preprocessed sensor data 118. In certain embodiments, the computing system may then input the data set preprocessed sensor data 118 into an ensemble machine-learning model 114 trained to generate a prediction of one or more features 119 of the detected one or more operational parameters based on the data set preprocessed sensor data 118.

For example, in certain embodiments, the ensemble machine-learning model 114 may include one or more of a convolutional neural network (CNN), a deep neural network (DNN), a deep convolutional neural network (DCNN), a vision transformer (ViT), one or more sequence-to-sequence (Seq2Seq) models, one or more encoder-decoder sequence models, one or more transformer models, or other ensemble of multiple, individual machine-learning models in which the output of each machine-learning model serves as the input to the next machine-learning model in the sequence until a final prediction of the one or more features 119 is generated.

In certain embodiments, the computing system may generate, based on the prediction of the one or more features 119, an explainable artificial-intelligence (XAI) output 124 associated with each individual machine-learning model of the ensemble machine-learning model 114. For example, in one embodiment, the XAI output 124 may include a human-understandable explanation or one or more indications of whether one or more machine-learning models of the ensemble machine-learning model 114 are generating predictions or making decisions using erroneous information (e.g., learned parameters or other information that may be internal to the machine-learning model) or generally performing poorly with respect to one or more other machine-learning models of the ensemble machine-learning model 114.

In certain embodiments, as further depicted by FIG. 1, the computing system may further perform a post-processing process 120 on the prediction of the one or more features 119 and generate published inference prediction 122. In certain embodiments, the computing system may utilize the XAI output 124 to generate one or more relative commonality scores 126 and one or more aggregated feature attributions 128 for each machine-learning model of the ensemble machine-learning model 114. For example, in one embodiment, the one or more relative commonality scores 126 may include one or more evaluation metrics indicative of how well each respective machine-learning model of the ensemble machine-learning model 114 performed with respect to generating the prediction of the one or more features 119.

For example, in some embodiments, the one or more relative commonality scores 126 may indicate that a machine-learning model of the ensemble machine-learning model 114 is performing well when the machine-learning model is generating predictions of certain features with an accuracy or confidence of “0.7”, “0.8”, “0.9”, or greater evaluated on a scale of “0.0” to “1.0”. In other embodiments, the one or more relative commonality scores 126 may indicate that a machine-learning model of the ensemble machine-learning model 114 is performing poorly when the machine-learning model is generating predictions of certain features with an accuracy or confidence of “0.2”, “0.3”, “0.4”, or less evaluated on a scale of “0.0” to “1.0”.

In certain embodiments, the one or more relative commonality scores may also indicate that a machine-learning model of the ensemble machine-learning model 114 is performing well when the XAI output 124 have low divergence or distributional shift across identified features with respect to all other machine-learned models in the ensemble 114 (e.g., low use of erroneous features). In another embodiment, the relative commonality scores may also indicate that a machine-learning model 114 is performing poorly when the XAI output 124 have a high divergence or distributional shift across identified features with respect to all other machine-learned models in the ensemble 114 (e.g., high use of erroneous features).

In certain embodiments, the one or more aggregated feature attributions 128 may include one or more evaluation metrics indicative of whether one or more machine-learning models of the ensemble machine-learning model 114 is making decisions using erroneous information (e.g., learned parameters or other information that may be internal to the machine-learning model) by computing, for example, one or more spatial attribution weight densities associated with each machine-learning model of the ensemble machine-learning model 114. As these densities can be computed. In certain embodiments, the computing system may then display a real-time or near real-time visual representation of the data set of unprocessed sensor data 116 utilizing the sensor data operator display 106 and the one or more aggregated feature attributions 128 utilizing the XAI operator display 104.

In certain embodiments, the computing system may further provide a real-time or near real-time display of the respective relative commonality scores 126 utilizing the relative commonality score indicators 110. In certain embodiments, in response to the one or more relative commonality scores 126 and the one or more aggregated feature attributions 128 displaying or indicating that one or more machine-learning models of the ensemble machine-learning model 114 performed poorly with respect to generating the prediction of the one or more features 119, the operator may then select one or more of the machine-learning model selectable affordances 108 corresponding to the one or more machine-learning models displayed or indicated as performing poorly to deactivate and/or decommission the low-performance machine-learning models while the high-performance machine-learning models of the ensemble machine-learning model 114 remain activated and/or commissioned for service. In another embodiment, the performance of the machine-learning models of the ensemble machine-learning model 114 may also be included as part of the XAI relative commonality score indicators 110.

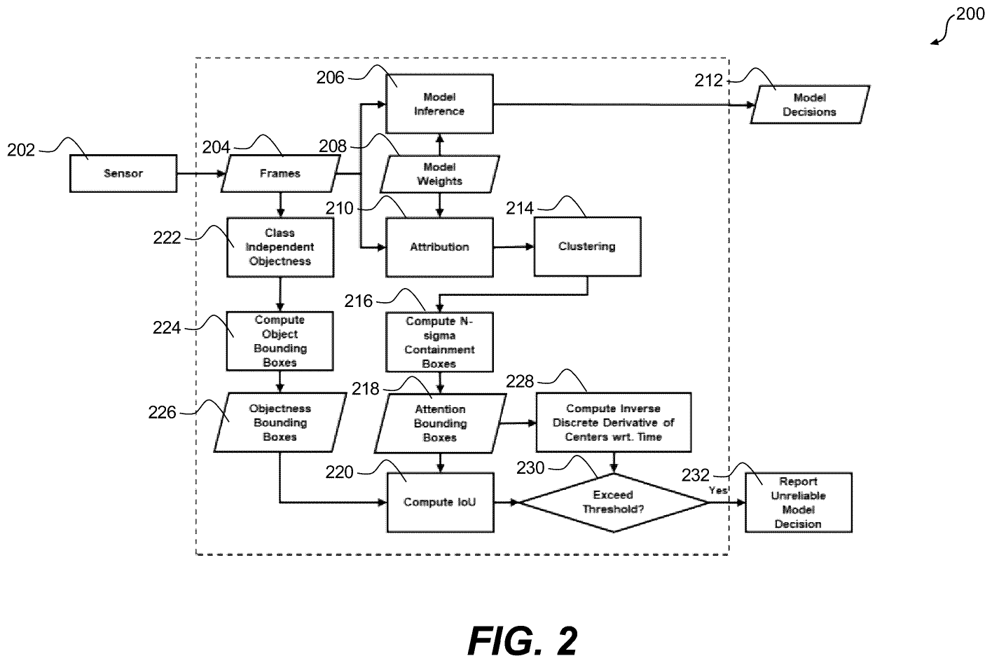

FIG. 2 illustrates a user-configurable ensemble machine-learning model inference workflow 200 for generating aggregated feature attributions of machine-learning models, in accordance with the presently disclosed embodiments. In certain embodiments, the user-configurable ensemble machine-learning model inference workflow 200 may be executed on a computing system, such as the computing system 400 as will be discussed below with respect to FIG. 4. Specifically, the user-configurable ensemble machine-learning model inference workflow 200 may include an aggregation of feature attribution heat maps and compute an intersection over union (IoU) between attention boxes and class independent objectness boxes. For example, the respective predictions of the machine-learning models of the ensemble machine-learning model 114 may be scored based on the IoU and the variance of the discrete derivative of an attention box location in pixel space with respect to time may be computed to score the consistency of object reports. In one example, if either score exceeds a threshold, the respective prediction may be flagged as inaccurate and displayed on UI 102 as an indication to the operator.

For example, as depicted by FIG. 2, the user-configurable ensemble machine-learning model inference workflow 200 may begin by receiving sensor output 202, which may be represented by one or more frames of pixel data 204. The user-configurable ensemble machine-learning model inference workflow 200 may then continue with generating machine-learning model inferences 206 (e.g., predictions) and decisions 212, training machine-learning model weights 208, and generating feature attributions 210. The user-configurable ensemble machine-learning model inference workflow 200 may then continue with performing a clustering 214 based on the feature attributions 210. The user-configurable ensemble machine-learning model inference workflow 200 may then continue with computing N-sigma containment boxes 216, generating attention bounding boxes 218, and computing an intersection over union (IoU) 220 between, for example, the attention bounding boxes 218 and class independent objectness bounding boxes 222.

In certain embodiments, returning to the frame of pixel data 204, the user-configurable ensemble machine-learning model inference workflow 200 may include generating the class independent objectness bounding boxes 222, computing object bounding boxes 224, and generating objectness bounding boxes 226. For example, in some embodiments, as depicted by FIG. 2, the intersection over union (IoU) 220 may be computed based on the attention bounding boxes 218 and the objectness bounding boxes 226. In certain embodiments, the user-configurable ensemble machine-learning model inference workflow 200 may then continue with computing an inverse discrete derivative 228 of an attention box location in pixel space with respect to time.

In certain embodiments, the user-configurable ensemble machine-learning model inference workflow 200 may then continue determining whether the one or more of the intersection over union (IoU) 220 and the inverse discrete derivative 228 exceeds a threshold value 230. In response to determining that one or more of the intersection over union (IoU) 220 and the inverse discrete derivative 228 exceeds the threshold value 230, the user-configurable ensemble machine-learning model inference workflow 200 may then conclude with flagging the corresponding machine-learning model of the ensemble machine-learning model 114 as generating inaccurate predictions or as otherwise performing poorly. The operator may then utilize the user-configurable ensemble machine-learning model system and UI to deactivate and/or decommission the low-performance machine-learning models while the high-performance machine-learning models of the ensemble machine-learning model remain activated and/or commissioned for service.

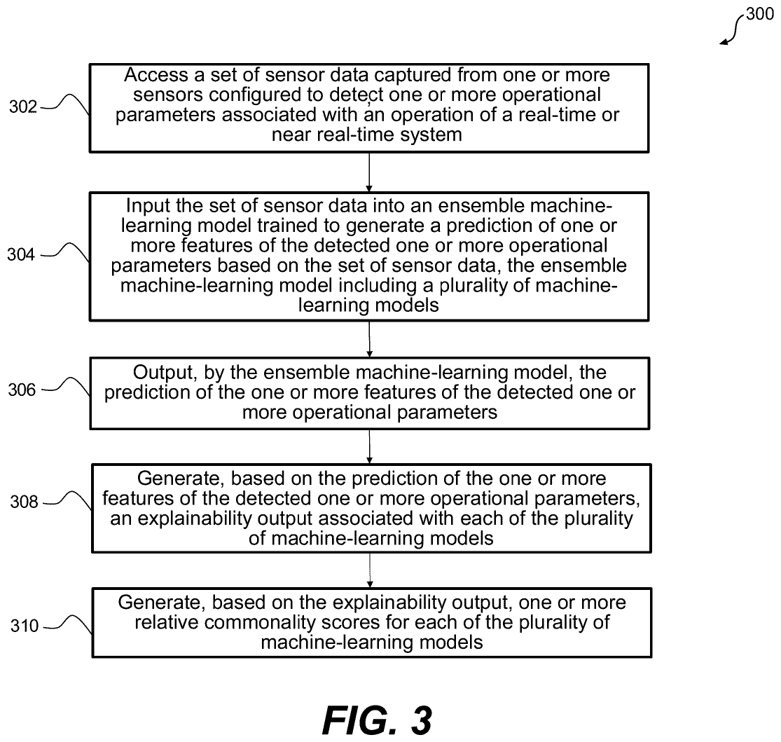

FIG. 3 illustrates a flow diagram of a method 300 for providing a user-configurable ensemble machine-learning model system and user interface (UI) suitable for monitoring and controlling the real-time or near real-time performance of an ensemble machine-learning model, in accordance with the presently disclosed embodiments. The method 300 may be performed utilizing one or more processing devices (e.g., one or more processors 402 as discussed below with respect to FIG. 3) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), a neuromorphic processing unit (NPU), or any other artificial intelligence (AI) accelerator device(s) that may be suitable for processing various data and making one or more predictions or decisions based thereon), firmware (e.g., microcode), or some combination thereof.

The method 300 may begin at block 302 with the one or more processors (e.g., one or more processors 402) accessing a set of sensor data captured from one or more sensors configured to detect one or more operational parameters associated with an operation of a real-time or near real-time system. For example, in one embodiment, the ensemble machine-learning model 114 may receive the preprocessed sensor data 118 for acting thereupon. The method 300 may continue at block 304 with the one or more processors (e.g., one or more processors 402) inputting the set of sensor data into the ensemble machine-learning model trained to generate a prediction of one or more features of the detected one or more operational parameters based on the set of sensor data. For example, in certain embodiments, the ensemble machine-learning model 114 may include a number of machine-learning models that may be trained end-to-end to generate a prediction of one or more features 119 of based on the data set of preprocessed sensor data 118, which may include a transformation of the data set of unprocessed sensor data 116 (e.g., real-time or near real-time raw sensor data).

The method 300 may continue at block 306 with the one or more processors (e.g., one or more processors 402) outputting, by the ensemble machine-learning model, the prediction of the one or more features of the detected one or more operational parameters. For example, in one embodiment, the ensemble machine-learning model 114 may output a prediction of one or more features 119 based on the preprocessed sensor data 118. The method 300 may continue at block 308 with the one or more processors (e.g., one or more processors 402) generating, based at least in part on the prediction of the one or more features of the detected one or more operational parameters, an explainability output associated with each of the plurality of machine-learning models. For example, in certain embodiments, the prediction of one or more features 119 may be utilized to generate an explainable artificial-intelligence (XAI) output 124, which may include a human-understandable explanation of the real-time or near real-time performance (e.g., real-time predictions or decisions) of each machine-learning model of the ensemble machine-learning model 114.

The method 300 may then conclude at block 310 with the one or more processors (e.g., one or more processors 402) generating, based at least in part on the explainability output, one or more relative commonality scores for each of the plurality of machine-learning models. For example, in certain embodiments, the XAI output 124 may be utilized to extract and generate relative commonality scores 126 and aggregated feature attributions 128. For example, in certain embodiments, the relative commonality scores 126 and aggregated feature attributions 128 may be displayed on the UI 102 to allow an operator to view and monitor in real-time or near real-time whether one or more machine-learning models of the ensemble machine-learning model 114 is generating predictions or making decisions using erroneous information (e.g., learned parameters or other information that may be internal to the model) or generally performing poorly. As previously discussed above with respect to FIG. 1, the operator may then utilize the one or more machine-learning model selectable affordances 108 as part of the UI 102 to select one or more machine-learning models for decommissioning in response to identifying the machine-learning models of the ensemble machine-learning model 114 that is performing poorly with respect to generating an accurate prediction of one or more features 119.

FIG. 4 illustrates an example computer system 400 that may be useful in performing one or more of the foregoing techniques as presently disclosed herein. In certain embodiments, one or more computer systems 400 perform one or more steps of one or more methods described or illustrated herein. In certain embodiments, one or more computer systems 400 provide functionality described or illustrated herein. In certain embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein.

As an example, and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate. In certain embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In certain embodiments, processor 402 includes hardware for executing instructions, such as those making up a computer program. As an example, and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In certain embodiments, processor 402 may include one or more internal caches for data, instructions, or addresses. This disclosure contemplates processor 402 including any suitable number of any suitable internal caches, where appropriate. As an example, and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402.

Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In certain embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 602. Although this disclosure describes and illustrates a particular processor, this disclosure contemplates any suitable processor.

In certain embodiments, memory 404 includes main memory for storing instructions for processor 402 to execute or data for processor 402 to operate on. As an example, and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In certain embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere).

One or more memory buses (which may each include an address bus and a data bus) may couple processor 402 to memory 404. Bus 412 may include one or more memory buses, as described below. In certain embodiments, one or more memory management units (MMUs) reside between processor 402 and memory 404 and facilitate accesses to memory 404 requested by processor 402. In certain embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In certain embodiments, storage 406 includes mass storage for data or instructions. As an example, and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In certain embodiments, storage 406 is non-volatile, solid-state memory. In certain embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In certain embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In certain embodiments, communication interface 410 includes hardware, software, or both providing one or more interfaces for communication (such as, for example, packet-based communication) between computer system 400 and one or more other computer systems 400 or one or more networks. As an example, and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it.

As an example, and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In certain embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, by one or more processors of a computing system, comprising:
accessing a set of sensor data captured from one or more sensors configured to detect one or more operational parameters associated with an operation of a real-time or near real-time system;
inputting the set of sensor data into an ensemble machine-learning model trained to generate a prediction of one or more features of the detected one or more operational parameters based at least in part on the set of sensor data, wherein the ensemble machine-learning model comprises a plurality of machine-learning models trained to generate the prediction of the one or more features of the detected one or more operational parameters;
outputting, by the ensemble machine-learning model, the prediction of the one or more features of the detected one or more operational parameters;
generating, based at least in part on the prediction of the one or more features of the detected one or more operational parameters, an explainability output associated with each of the plurality of machine-learning models; and
generating, based at least in part on the explainability output, one or more relative commonality scores for each of the plurality of machine-learning models.

2. The method of claim 1, further comprising causing a user interface (UI) executing on a computing device to display a real-time or near real-time visual representation of the explainability output and the set of sensor data.

3. The method of claim 2, further comprising causing the UI executing on the computing device to display a visual representation of the one or more relative commonality scores for each of the plurality of machine-learning models.

4. The method of claim 1, wherein generating the one or more relative commonality scores further comprises generating one or more evaluation metrics indicative of how well each respective machine-learning model of the plurality of machine-learning models performed with respect to generating the prediction of the one or more features of the detected one or more operational parameters.

5. The method of claim 1, further comprising:
identifying, based at least in part on the one or more relative commonality scores, that one or more machine-learning models of the plurality of machine-learning models performed poorly with respect to generating the prediction of the one or more features of the detected one or more operational parameters; and
decommissioning the identified one or more machine-learning models.

6. The method of claim 1, further comprising generating, based at least in part on the explainability output, one or more aggregated feature attributions for each of the plurality of machine-learning models.

7. The method of claim 1, wherein the ensemble machine-learning model comprises one or more of a convolutional neural network (CNN), a deep neural network (DNN), a deep convolutional neural network (DCNN), a vision transformer (ViT), one or more sequence-to-sequence (Seq2Seq) models, one or more encoder-decoder sequence models, or one or more transformer models.

8. A computing system, comprising:
one or more non-transitory computer-readable storage media including instructions; and
one or more processors coupled to the one or more non-transitory computer-readable storage media, the one or more processors configured to execute the instructions to:
access a set of sensor data captured from one or more sensors configured to detect one or more operational parameters associated with an operation of a real-time or near real-time system;
input the set of sensor data into an ensemble machine-learning model trained to generate a prediction of one or more features of the detected one or more operational parameters based at least in part on the set of sensor data, wherein the ensemble machine-learning model comprises a plurality of machine-learning models trained to generate the prediction of the one or more features of the detected one or more operational parameters;
output, by the ensemble machine-learning model, the prediction of the one or more features of the detected one or more operational parameters;
generate, based at least in part on the prediction of the one or more features of the detected one or more operational parameters, an explainability output associated with each of the plurality of machine-learning models; and
generate, based at least in part on the explainability output, one or more relative commonality scores for each of the plurality of machine-learning models.

9. The computing system of claim 8, wherein the instructions further comprise instructions to cause a user interface (UI) executing on a computing device to display a real-time or near real-time visual representation of the explainability output and the set of sensor data.

10. The computing system of claim 9, wherein the instructions further comprise instructions to cause the UI executing on the computing device to display a visual representation of the one or more relative commonality scores for each of the plurality of machine-learning models.

11. The computing system of claim 8, wherein the instructions to generate the one or more relative commonality scores further comprise instructions to generate one or more evaluation metrics indicative of how well each respective machine-learning model of the plurality of machine-learning models performed with respect to generating the prediction of the one or more features of the detected one or more operational parameters.

12. The computing system of claim 8, wherein the instructions further comprise instructions to:
identify, based at least in part on the one or more relative commonality scores, that one or more machine-learning models of the plurality of machine-learning models performed poorly with respect to generating the prediction of the one or more features of the detected one or more operational parameters; and
decommission the identified one or more machine-learning models.

13. The computing system of claim 8, wherein the instructions further comprise instructions to generate, based at least in part on the explainability output, one or more aggregated feature attributions for each of the plurality of machine-learning models.

14. The computing system of claim 8, wherein the ensemble machine-learning model comprises one or more of a convolutional neural network (CNN), a deep neural network (DNN), a deep convolutional neural network (DCNN), a vision transformer (ViT), one or more sequence-to-sequence (Seq2Seq) models, one or more encoder-decoder sequence models, or one or more transformer models.

15. A non-transitory computer-readable medium comprising instructions that, when executed by one or more processors of a computing system, cause the computing system to:
access a set of sensor data captured from one or more sensors configured to detect one or more operational parameters associated with an operation of a real-time or near real-time system;
input the set of sensor data into an ensemble machine-learning model trained to generate a prediction of one or more features of the detected one or more operational parameters based at least in part on the set of sensor data, wherein the ensemble machine-learning model comprises a plurality of machine-learning models trained to generate the prediction of the one or more features of the detected one or more operational parameters;
output, by the ensemble machine-learning model, the prediction of the one or more features of the detected one or more operational parameters;
generate, based at least in part on the prediction of the one or more features of the detected one or more operational parameters, an explainability output associated with each of the plurality of machine-learning models; and
generate, based at least in part on the explainability output, one or more relative commonality scores for each of the plurality of machine-learning models.

16. The non-transitory computer-readable medium of claim 15, wherein the instructions further comprise instructions to cause a user interface (UI) executing on a computing device to display a real-time or near real-time visual representation of the explainability output and the set of sensor data.

17. The non-transitory computer-readable medium of claim 16, wherein the instructions further comprise instructions to cause the UI executing on the computing device to display a visual representation of the one or more relative commonality scores for each of the plurality of machine-learning models.

18. The non-transitory computer-readable medium of claim 15, wherein the instructions to generate the one or more relative commonality scores further comprise instructions to generate one or more evaluation metrics indicative of how well each respective machine-learning model of the plurality of machine-learning models performed with respect to generating the prediction of the one or more features of the detected one or more operational parameters.

19. The non-transitory computer-readable medium of claim 15, wherein the instructions further comprise instructions to:
identify, based at least in part on the one or more relative commonality scores, that one or more machine-learning models of the plurality of machine-learning models performed poorly with respect to generating the prediction of the one or more features of the detected one or more operational parameters; and
decommission the identified one or more machine-learning models.

20. The non-transitory computer-readable medium of claim 15, wherein the instructions further comprise instructions to generate, based at least in part on the explainability output, one or more aggregated feature attributions for each of the plurality of machine-learning models.
